(19) United States
(12) Patent Application Publication
(10) Pub. No.: US 2021/0185945 A1
(43) Pub. Date: Jun. 24, 2021

(54) ILLUMINATED IRRIGATION SYSTEM

(71) Applicant: Matthew Richardville, Vincennes, IN (US)

(72) Inventor: Matthew Richardville, Vincennes, IN (US)

(21) Appl. No.: 17/126,635

(22) Filed: Dec. 18, 2020

Related U.S. Application Data
(60) Provisional application No. 62/951,445, filed on Dec. 20, 2019.

(51) Int. Cl. A01G 25/09; A01G 25/16

(52) U.S. Cl. CPC A01G 25/092; A01G 25/162

(57) ABSTRACT

A light assembly mounted to a span of an irrigation system. The light assembly includes at least one bracket, at least one extension, and a light bar. In one variation, the light assembly is powered by the power supply of the irrigation system. In another variation, the light assembly is powered independent of the irrigation system. In one form, the light assembly is controlled to turn on when natural light is not available and controlled to turn off when natural light is available. As a result, a crops exposure to light during short periods of daylight is increased.

### CROSS-REFERENCE TO RELATED APPLICATIONS

This application claims the benefit of U.S. Provisional Application No. 62/951,445, filed Dec. 20, 2019, which is hereby incorporated by reference.

### BACKGROUND

Crop growth depends on four primary factors. Those factors are light, water, temperature, and nutrients. In the spring and fall, temperatures may still be warm enough to support crop growth. However, the lack of adequate sunlight can prevent crops from growing as well as in the summer months. The short days restrict the crops ability to remain in photosynthesis. Photosynthesis is the natural process that occurs when plants use light energy and carbon dioxide to make the food they need to grow. Therefore, increasing the amount of time that the crops are exposed to light will increase the time period for photosynthesis. The more time that a crop is able to be in its photosynthetic stage, the greater the yield will be from that crop.

### BRIEF DESCRIPTION OF THE DRAWINGS

FIG. 1 is a perspective view of a center pivot irrigation system.

FIG. 2 is a perspective view of a lateral move irrigation system.

FIG. 3 is a perspective view of a light assembly mounted to a center pivot irrigation system.

FIG. 4 is a front view of a light assembly.

FIG. 5 is a side view of a light assembly.

FIG. 6 is a side view of a light assembly extension.

FIG. 7 is a front view of a light assembly extension.

FIG. 8 is a flowchart depicting a logic process for a light assembly.

FIG. 9 is a top view of a crop coverage area divided into one or more individual crop areas.

FIG. 10 is a perspective view of a center pivot irrigation system with varying levels of radiant flux.

### DESCRIPTION OF THE SELECTED EMBODIMENTS

For the purpose of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates. One embodiment of the invention is shown in great detail; although it will be apparent to those skilled in the relevant art that some features that are not relevant to the present invention may not be shown for the sake of clarity.

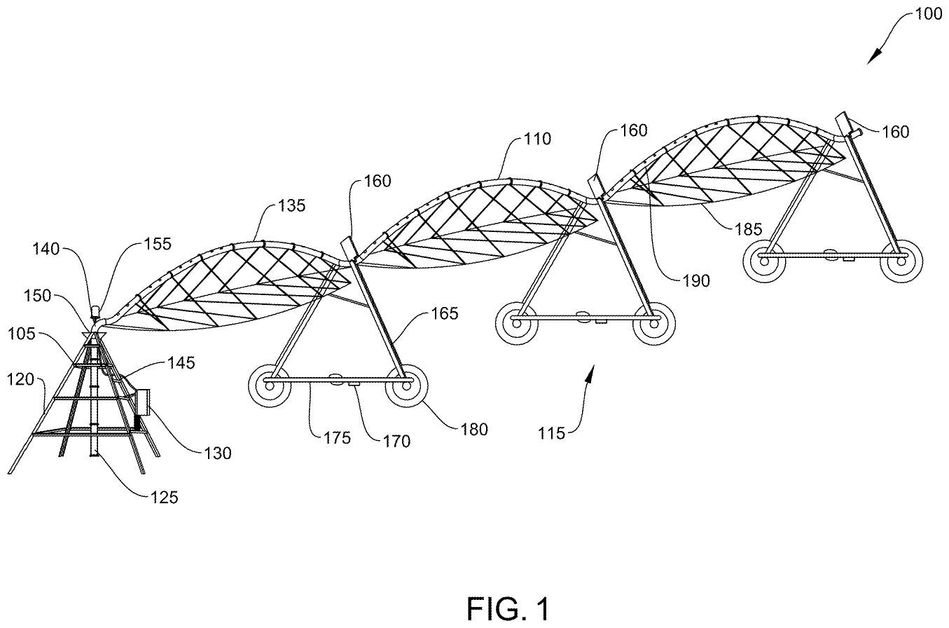

FIG. 1 shows an example of a center pivot type irrigation system 100, the center pivot type irrigation system 100 has a pivot point 105, one or more spans 110, and one or more drive units 115.

The pivot point 105 has one or more pivot legs 120, a riser pipe 125, and a control panel 130. The pivot legs 120 serve to support the pivot point 105 and provide a solid base for the center point irrigation system 100. The riser pipe 125 is connected to a first span 135 through a pivot swivel 140. The riser pipe 125 serves to transport water from a source to the first span 135. The control panel 130 is mounted to the pivot point 105. The control panel 130 serves to command the center pivot irrigation system 100 to start, stop, move in reverse, and/or pump water. Optionally, the control panel 130 may command auxiliary equipment, such as lighting, to power on or off.

The control panel 130 further includes an irrigation wiring system 145. The irrigation wiring system 145 runs from the control panel 130 through a J-pipe 150 and into a collector ring 155. The collector ring 155 includes brass rings with contact brushes that allow for a continuous flow of electricity even as the machine rotates around the pivot point 105. From the collector ring 155, the irrigation wiring system 145 runs across the one or more spans 110 to one or more tower boxes 160. The tower boxes 160 work to support and control the movement of the center pivot irrigation system 100. The tower boxes 160 are configured to work with the one or more drive units 115 to control movement.

The drive units 115 include one or more span supports 165, a drive motor 170, a driveshaft 175, and one or more wheels 180. The span supports 165 serve to support the spans at or above the crop level. The drive motor 170 is commanded by the tower box 160 to move in a certain direction at a certain speed. The drive motor 170 spins the driveshaft 175 which in turn spins the one or more wheels 180. The connection between the tower box 160 and the drive motor 170 keeps the irrigation system moving in the proper direction at a consistent speed.

The one or more spans 110, including the first span 135, have at least one supportive truss 185. The supportive truss 185 serves to support the spans to reduce drooping as a result of the contained water. Furthermore, the supportive truss 185 works to maintain the integrity of the spans in the event of high winds or inclement weather. The one or more spans 110, including the first span 135, further include at least one sprinkler 190. The sprinkler serves to distribute the water that is pumped through the riser pipe 125 to the spans 110.

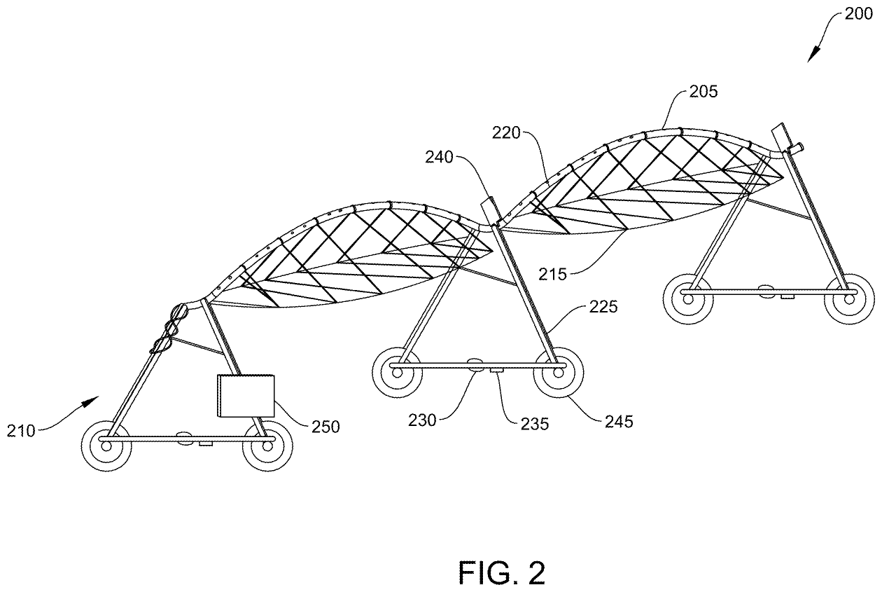

FIG. 2 shows a lateral move type irrigation system 200. The lateral move type irrigation system 200 operates similarly to the center pivot type system discussed in FIG. 1. For ease of understanding the similar components will not be discussed in great detail, for reference see FIG. 1.

The lateral move type irrigation system 200 includes one or more spans 205 supported by one or more support structures 210. Similar to FIG. 1, the spans 205 are supported by a truss system 215. The truss system 215 serves to distribute the weight of the spans 205 when the system is operating and the spans 205 are full of water. Additionally, the truss system 215 adds durability to the irrigation system. This reduces the cost of maintenance and increases the life of the irrigation system. Located on the spans 205 are one or more sprinklers 220. The one or more sprinklers 220 serve to distribute the water from inside the spans to the surrounding crops.

The support structures 210 serve to maintain the span height needed by supporting the spans 205. The support structures 210 include one or more span supports 225, a drive motor 230, a drive shaft 235, and one or more wheels 245. The span supports 225 serve to provide a solid mounting location for the spans 205 and a control panel 250. The control panel 250 serves as the location to power the irrigation system on or off and also to set the speed and direction of movement. To begin locomotion a command tower 240 sends a movement signal, indicating the speed and direction of movement, to the drive motor 230. The drive motor 230 then begins to rotate the driveshaft 235. The rotation of the driveshaft 235 in turn creates a rotation of the one or more wheels 245 which moves the irrigation system. In the lateral move system the command towers 240 communicate with one another in order to maintain consistency in the speed and direction of movement. This allows the irrigation system to move uniformly and avoid putting undue stress on the spans.

A distinction between the center pivot type irrigation system discussed in FIG. 1 and the lateral move type irrigation system 200 is the method for obtaining water. The center pivot system has water pumped through the riser pipe 125 whereas the lateral move system must either drag a hose connected to a water source or have a water channel running parallel with the movement of the lateral move system to draw water from.

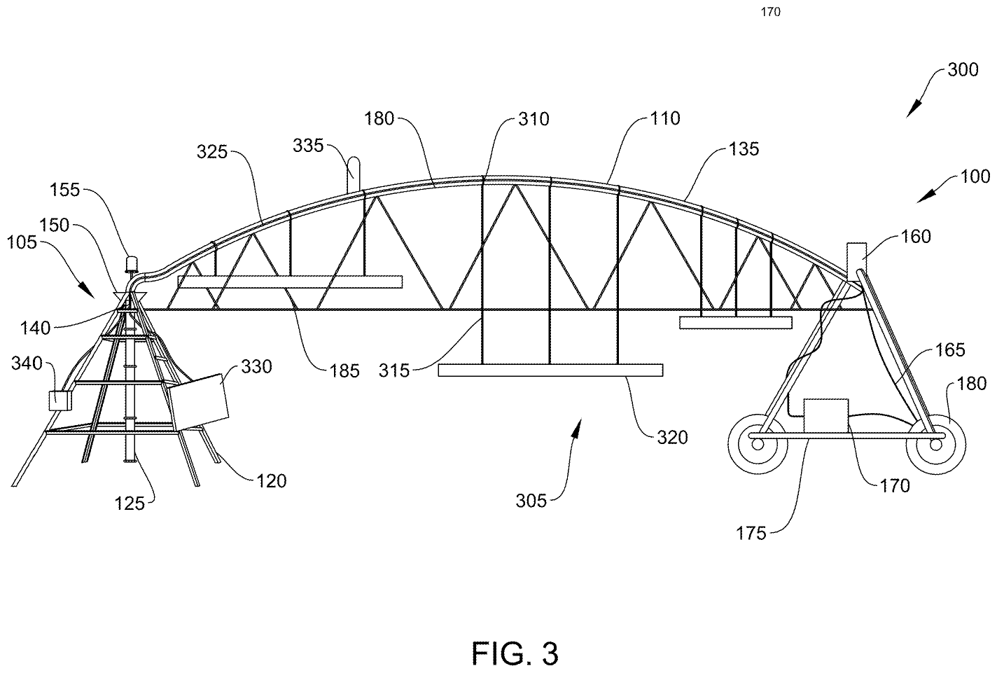

FIG. 3 shows one example of an illuminated irrigation system 300. The illuminated irrigation system 300 shown in FIG. 3 includes the center pivot type irrigation system 100 and a light assembly 305. For the sake of clarity, the individual aspects of the center pivot irrigation system 100 will not be discussed again in great detail. Instead, see FIG. 1 for a detailed explanation of the center pivot irrigation system.

The light assembly 305 includes one or more brackets 310, one or more extensions 315, and a light bar 320. The bracket 310 is configured to surround the span 110 and attaches via clamping force. Descending from the bracket is the extension 315. The extension 315 is variable along its length. For example, the extension may be set to allow for the light bar 320 to hang anywhere from 1-10 meters above the ground. In an example embodiment, the light bar 320 is hung approximately 3.5 meters above the ground. In another embodiment, the light bar 320 is hung approximately 3.5 meters above the top of the crop. At the end of the extension 315 opposite of the bracket 310 is the light bar 320. The light bar 320 is generally connected to the extension 315. However, the light 320 bar may optionally be connected directly to the brackets 310. The light bar 320 includes multiple grow lights to aid in crop growth when sun exposure is low. The grow lights may be of the Light Emitting Diode (LED) type, the High Intensity Discharge (HID) type, the fluorescent type, and/or the plasma type. Light bar 320 is generally configured to emit light in a generally downward direction and may optionally include reflectors to divert light emitted in other directions in the generally downward direction.

The light assembly 305 is generally powered by the irrigation systems existing power grid. For example, a light assembly wire 325 is attached at one end to the control panel 330 and at the other end to the light bar 320. This configuration allows for the light assembly 305 to be activated when the irrigation system is active. However, this configuration may be modified by the addition of a light timer 335. The light timer 335 connects between the control panel 330 and the light assembly 305. The light timer 335 serves to prevent the flow of power into the light assembly until a certain pre condition is met. For example, the sun sets at 6 PM and rises at 8 AM, the light timer 335 may be set to allow power flow from 6 PM to 8 AM when the sun is down. This increases the crops exposure to light and increases the time of photosynthesis. Additionally, multiple light assemblies 305 and light timers 335 may be connected together in order to cover multiple span lengths.

In a different configuration, the light assembly 305 may be powered independent of the irrigation system. For example, the light assembly wire 325 is attached at one end to the light assembly control panel 340 and at the other end to the light bar 320. In this configuration, the light assembly does not rely on power from the control panel 330. Additionally, logic may be implemented into the light assembly control panel 340 to monitor the environment for sunlight. When sunlight is not available the logic may command that power be applied to the light assembly 305. In this configuration the light timers 335 are unnecessary and the process becomes more autonomous.

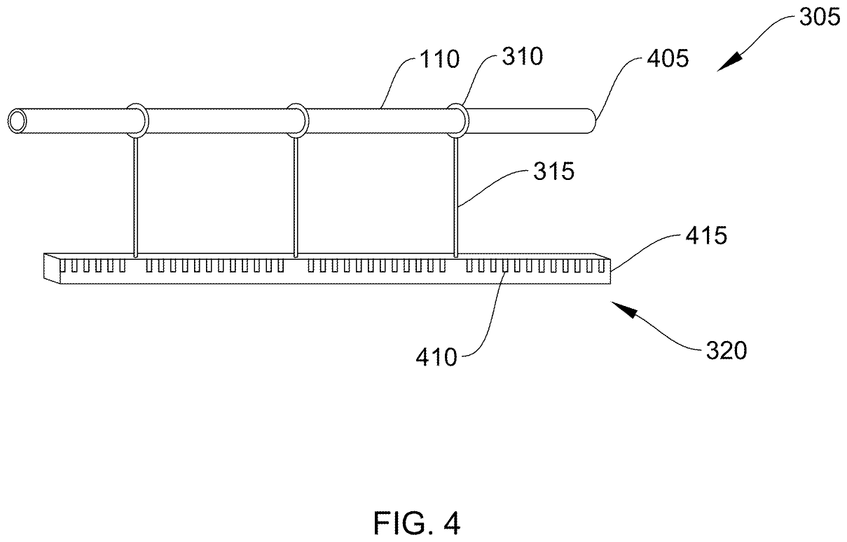

The light assembly of FIG. 3 is shown in more detail in FIG. 4. The light assembly 305 includes the brackets 310, the extensions 315, and the light bar 320. The bracket 310 is operationally coupled to the span 110 of the irrigation system. In another embodiment, the bracket 310 is operationally coupled to the supportive truss system 185. Enclosed within the span 110 is a water pipe 405. The water pipe 405 serves to transport and distribute water throughout the irrigation system. The bracket 310 may be in the form of a pipe clamp. Some options for the type of pipe clamp may be rigid clamps, adjustable clamps, cushioned clamps, and/or U-bolt clamps. Attached to the bracket 310 is the extension 315. The extension 315 is adjustable in terms of length. For example, the extension may be set to allow for the light bar 320 to hang anywhere from 1-10 meters above the ground. In an example embodiment, the light bar is hung approximately 3.5 meters above the ground. Additionally, the extension 315 is able to be operationally coupled to another extension 315 in order to extend the operational length beyond that of a single extension component.

At the end of the extension 315 opposite the bracket 310 is the light bar 320. The light bar 320 is generally connected to the extension 315. However, the light 320 bar may optionally be connected directly to the brackets 310. The light bar 320 includes one or more grow lights 410 to aid in crop growth when sun exposure is low. The grow lights 410 may be of the Light Emitting Diode (LED) type, the High Intensity Discharge (HID) type, the fluorescent type, and/or the plasma type. The grow lights 410 are contained inside of a light housing 415. The light housing 415 serves to protect the grow lights 410 from inclement weather, debris, and to focus the emitted light in the intended direction. The light housing 415 may be made of a metallic or polymeric material and sized according to the individual needs of the user. For example, the light bar may be anywhere from 1-20 meters long depending on the application.

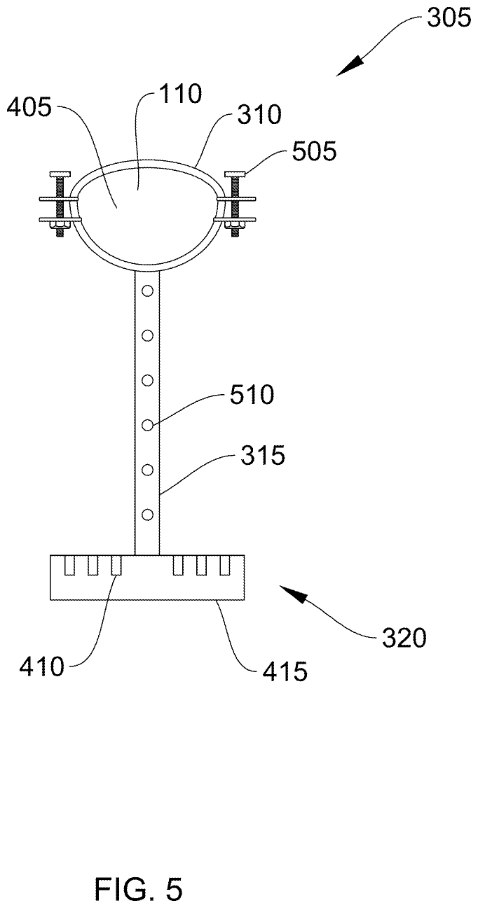

The light assembly of FIG. 4 is shown in more detail in FIG. 5. The bracket 310 is secured around the span 110 by one or more fasteners 505. The fasteners 505 serve to secure the bracket 310 on the span 110 by creating a clamping force. The fasteners 505 may be of any type. For example, the fasteners may be screws, bolts, welds, glues, magnets, clamps, and/or rivets.

Attached to the bracket 310 is the extension 315. The extension 315 is adjustable in terms of length. For example, the extension may be set to allow for the light bar 320 to hang anywhere from 1-10 meters above the ground. In an example embodiment, the light bar is hung approximately 3.5 meters above the ground. Additionally, the extension 315 is able to be operationally coupled to another extension 315 in order to extend the operational length beyond that of a single extension component. The adjustability of the extension 315 is accomplished by one or more adjustment holes 510. The adjustment holes 510 allow for the light bar 320 to be placed higher up towards the span 110 or lower down towards the crops. The adjustment of the light bar 320 allows for the optimal light exposure for the particular crops being grown. For example, placing the light bar 320 close to the top of the crops results in a very narrow coverage area. As a result, this creates an inefficient lighting system. However, placing the light bar 320 far from the top of the crops allows the light to disperse and lose strength. As a result, there is less light absorption by the crops and therefore less photosynthesis and growth. Therefore, adjusting the light bar 320 allows for the distance from the top of the crops to the light bar to be variable. This variability allows for ideal light exposure conditions to be created where the light bar 320 is close enough to the crops to supply additional light, but, also far enough from the crops to cover a broad area and remain efficient.

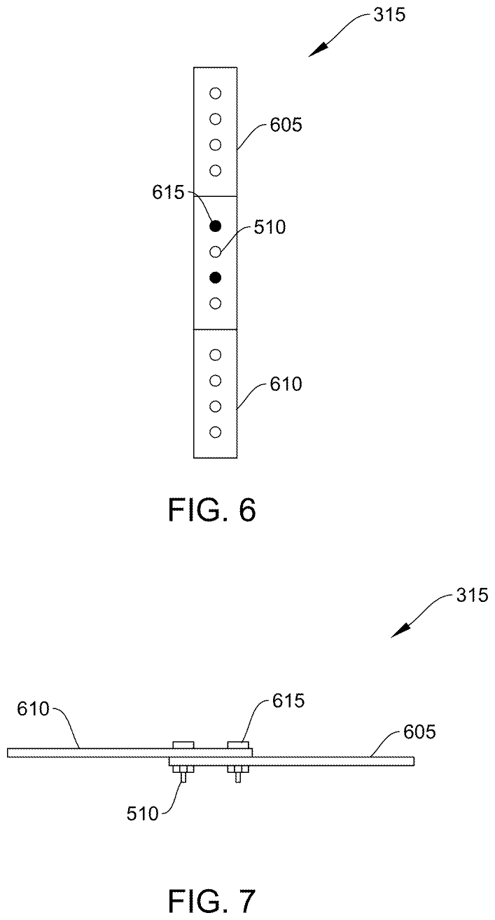

Moving to FIG. 6 the extension 315 is shown in connection with a second extension 315 in order to increase the operational length. To combine multiple extensions, a process is completed as follows. A first extension 605 and a second extension 610 are adjusted to the intended operational length. The extensions are then further adjusted until the holes 510 of the first extension 605 and the second extension 610 are in alignment. Following the alignment of the holes 510, one or more fasteners 615 are inserted through the holes 510 in order to secure the first extension 605 and the second extension 610 together. The fasteners 615 may be of any type. For example, the fasteners may be screws, bolts, welds, glues, magnets, clamps, and/or rivets.

FIG. 7 shows the extensions of FIG. 6 from a front view. As shown in FIG. 7 the first extension 605 and the second extension 610 are connected together by the fastener 615 in a sandwich configuration. The sandwich configuration allows the fastener 615 to exert a clamping force on the first extension 605 and the second extension 610. This clamping force maintains the positioning of the extensions in the event of strong winds or other inclement weather.

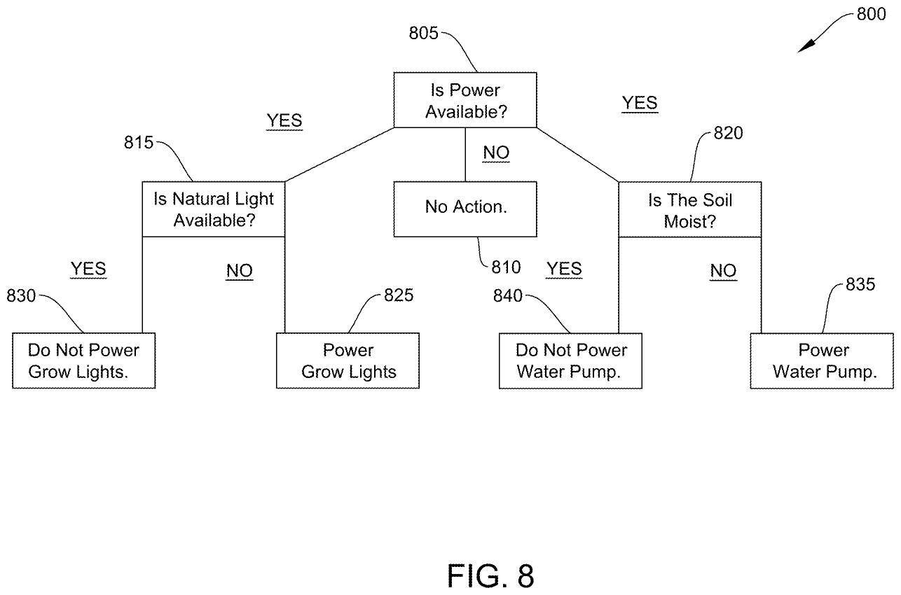

An example of a logic flowchart 800 is shown in FIG. 8. The logic flowchart 800 gives an example of the operational logic behind the intended light assembly usage. The logic flowchart 800 has separate pathways for grow light applications and sprinkler applications. The individual pathways allow the grow lights and the sprinkler system to run independently of each other. For example, the logic begins with a step 805. Step 805 tests power flow to see if the breaker is closed and allowing power into the irrigation system. If no power is entering the irrigation system then a step 810 commences.

If power is available, the irrigation system moves on to a step 815 and a step 820. In step 815 the irrigation system tests for available sunlight. Testing for light may be done by using a light sensor. For example, photo-conductive cells may be used to determine if sunlight is available. Additionally, other types of light sensors may be used such as photo-emissive cells, photo-junction devices, and/or photo-voltaic cells.

If natural light is not available, the logic moves to a step 825. Step 825 instructs the irrigation system power supply to apply power to the grow lights. The addition of the grow lights results in more light exposure for crops. The longer light exposure creates a longer period for photosynthesis and crop growth.

If natural light is available, the logic moves to a step 830. Step 830 instructs the irrigation system power supply to withhold power from the grow lights. Withholding power from the grow lights during times where natural light is available prevents wasted electricity. Additionally, withholding power saves costs in electricity and wear and tear on the light assembly equipment.

In step 820, the irrigation system tests for proper soil moisture levels. Testing soil moisture levels may be done using tensiometers and resistance or neutron probe methods. Additionally, some irrigation systems are set on a timer. The timer starts the water flow and irrigation based on a constant time of day or week.

If the soil is not moist, the logic moves to a step 835. Step 835 instructs the water pump to begin working to force water through the spans of the irrigation system and out of the sprinklers. The sprinklers then move over the crop area and moisten the ground to the proper levels. The added moisture gives the crops the water needed for growth and increases yield.

If the soil is moist, the logic moves to a step 840. Step 840 instructs the water pump power supply to withhold power from the water pump. Withholding power from the water pump, during times where the crops have already been watered by rain or other means, prevents over watering. Additionally, withholding power from the water pump, when not needed, creates a more efficient system. The more efficient system saves money in operation costs, electricity, and wear and tear on the pump and associated equipment.

The separation of the logic for the operation of the grow lights and the sprinklers allows for the independent operation of each. For example, the sprinkler system may not be running, but, the grow lights may be on. In another example, the sprinkler system may be running, but, the grow lights may be off. In yet another example, both the sprinkler system and the grow light may be operating. This flexibility allows for the systems to operate in the most efficient manner possible in order to maximize the crops growth potential.

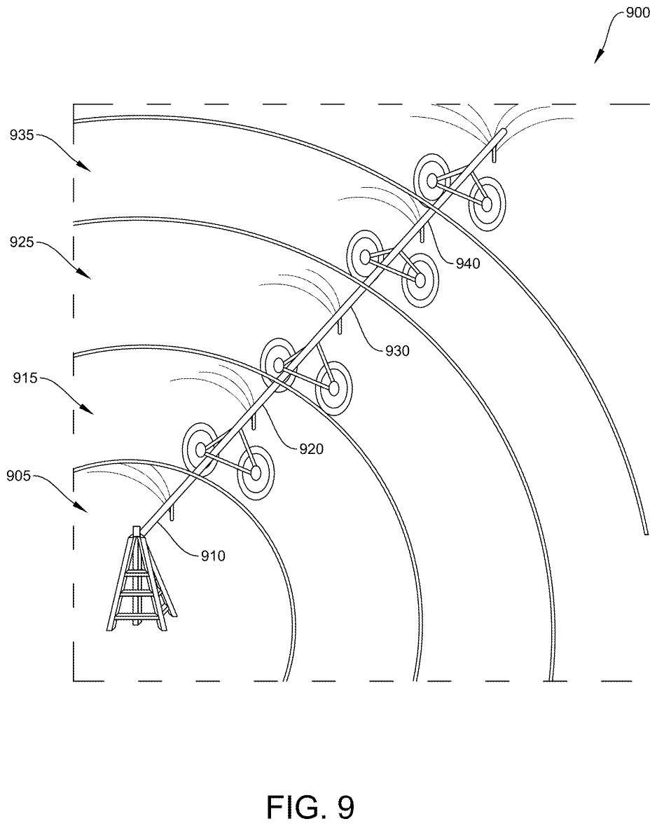

FIG. 9 depicts a crop coverage area 900 that is broken up into sections. In this example, the crop coverage area 900 is broken into sections based on the span locations. However, in other embodiments the crop coverage area 900 may be broken into sections based on crop type, section area, and/or natural environmental factors.

The crop areas can be calculated using a simple equation. For a first crop area 905, the equation used is A=pi*r² where A is area, pi is a constant, and r is radius. However, when calculating the areas surrounding the first crop area 905, a different equation should be used. The equation for a second crop area 915 and subsequent areas is A=pi*(r₂²−r₁²) where A is area, pi is a constant, r₂ is the radius from the center to the outer rim of the second crop area 915, and r₁ is the radius from the center to the outer rim of the first crop area 905.

In this example, each crop area is covered by a corresponding span. For example, the first crop area 905 is covered by a first span 910, the second crop area 915 is covered by a second span 920, a third crop area 925 is covered by a third span, and a fourth crop area 935 is covered by a fourth span 940. It should be appreciated that any number of spans may be connected to achieve the length needed to cover the crop area. For example, anywhere from 1-100 spans may be connected together to reach the required length.

As a result of the difference in crop areas, due to different distances from a pivot point, different levels of radiant flux (light intensity/radiant energy emitted per unit time) may be necessary in order to provide consistent growth conditions in each crop area. In the illustrated example, the first crop area 905 is smaller than the fourth crop area 935. As should be appreciated, a smaller crop area will not require as much radiant flux as will a larger crop area. To create different levels of radiant flux, one or more light assemblies and/or light assemblies with different radiant flux output may be mounted to individual spans.

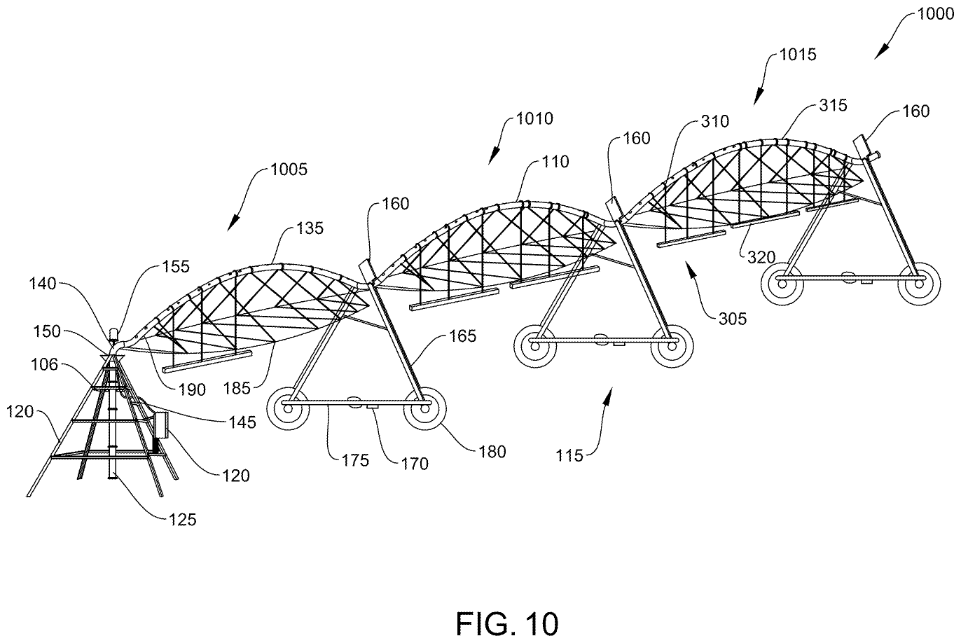

FIG. 10 shows an example of an irrigation system with varying levels of radiant flux 1000. As discussed previously in FIG. 9, different crop areas may have a need for different light intensities to achieve optimal growth conditions. Generally, as the length of the irrigation system grows longer the area covered by each span section grows larger. The result is a need for greater radiant flux with each span distance away from the pivot point 105 to obtain similar radian flux compared to closer span sections. Shown in FIG. 10 is a method of maintaining the optimal radiant flux by adding or subtracting light assemblies 305. For example, the first span 135 has a first radiant flux 1005 that corresponds to the area covered by the first span 135. The span 110 that follows the first span 135 has a second radiant flux 1010 that is greater than the first radiant flux 1005. The larger radiant flux corresponds to the larger area and maintains the optimal grow conditions. The subsequent span 110 has a third radiant flux 1015 that corresponds to the greater area and continues to maintain the optimal grow conditions. It should be appreciated that the light assemblies 305 are removable and may be added or removed as the situation warrants in order to maintain the optimal grow conditions.

In another example, the radiant flux may optionally be controlled by regulating the power flow into the light assembly 305. Modulating the radiant flux by regulating the power flow would allow for a uniform number of light assemblies 305 while still controlling the light output. In a further example, the radiant flux may be regulated by using different light sources. For example, one light bar 320 may be of the LED type while another light bar 320 may be of the HID type. In yet another example, the radiant flux may be regulated by using light sources with different radiant flux output (power).

It should be noted that the methods described in FIGS. 9 and 10 generally pertain only to center pivot type irrigation systems. With the lateral move type irrigation system the area covered is uniform and as a result a uniform radiant flux is generally preferred.

1. An illuminated irrigation system, wherein the irrigation system includes one or more vertical supports, one or more horizontal spans supported by the one or more vertical supports, a fluid transport system attached to or extending through at least a portion of the one or more horizontal spans, and a water distribution system operationally coupled to the fluid transport system to distribute water below the one or more horizontal spans, the light assembly comprising:
a light assembly;
a bracket mounting said light assembly to the irrigation system; and
an extension positioning said light assembly a predetermined distance from an intended surface.

2. The illuminated irrigation system as in claim 1, wherein the bracket is mounted to a horizontal span of the irrigation system.

3. The illuminated irrigation system as in claim 1, wherein the irrigation system is a center pivot type irrigation system.

4. The illuminated irrigation system as in claim 1, wherein the irrigation system is a lateral move type irrigation system.

5. The illuminated irrigation system as in claim 1, wherein the light source comprises Light Emitting Diode (LED) type grow lights.

6. The illuminated irrigation system as in claim 1, wherein the light source comprises High Intensity Discharge (HID) type grow lights.

7. The illuminated irrigation system as in claim 1, wherein the light assembly is powered by an existing electrical power from the irrigation system.

8. The illuminated irrigation system as in claim 1, wherein the light assembly is powered independently from the irrigation system.

9. The illuminated irrigation system as in claim 1, wherein the light assembly extension has a first end and a second end, wherein the distance between the first end and the second end defines a length, and wherein the length is adjustable.

10. The illuminated irrigation system as in claim 1, wherein a minimum length of a horizontal span is 100 feet, and wherein the minimum length is measured as the unsupported horizontal span distance between two vertical supports.

11. The illuminated irrigation system as in claim 10, wherein a maximum length of a horizontal span is 400 feet, and wherein the length is measured as the unsupported horizontal span distance between two vertical supports.

12. The illuminated irrigation system as in claim 1, wherein a plurality of the horizontal spans are operationally coupled together, in an end to end configuration, in order to reach a predetermined length.

13. A system comprising:
an irrigation system comprising:
one or more vertical supports,
one or more horizontal spans supported by the one or more vertical supports,
a fluid transport system attached or extending through at least a portion of the one or more horizontal spans, and
a water distribution system operationally coupled to the fluid transport system to distribute water below the one or more horizontal spans;
a light assembly comprising:
a bracket for mounting said light assembly to the irrigation system, and
a light source removably secured to said bracket, wherein said light source comprises LED type grow lights.

14. A system as in claim 13, wherein the bracket is mounted to a horizontal span of the irrigation system.

15. A system as in claim 13, wherein the irrigation system is a center pivot type irrigation system.

16. A system as in claim 13, wherein the irrigation system is a lateral move type irrigation system.

17. The system of claim 15, wherein the plurality of light assemblies are arranged so that the emitted radiant flux increases approximately proportionately to a square of the distance of a particular light assembly from a pivot point.

18. The system of claim 15, wherein the plurality of light assemblies have variable emitted radiant flux and wherein the plurality of light assemblies are arranged so that the emitted radiant flux increases approximately proportionately to a square of the distance of a particular light assembly from a pivot point.

19. A method of increasing crop light absorption by retrofitting an irrigation system with grow lights comprising:
attaching grow lights to one or more horizontal spans of the irrigation system, wherein the grow lights are attached to the one or more horizontal spans using one or more brackets,
connecting said grow lights to a power control box, wherein the power control box also controls the movement of the irrigation system, and
powering the grow lights during specified time periods to extend the time period for light absorption.

20. The method of claim 19, wherein the grow lights have variable emitted radiant flux and wherein the grow lights are arranged so that the emitted radiant flux increases approximately proportionately to a square of the distance of a particular light assembly from a pivot point of a center pivot type irrigation system.
